(19) United States
(12) Patent Application Publication
(10) Pub. No.: US 2023/0311436 A1
(43) Pub. Date: Oct. 5, 2023

(54) ACTUATORS

(71) Applicant: Microtecnica S.r.l., Torino (IT)

(72) Inventors: Dario Molinelli, Carnate (IT); Michele Restuccia, Milano MI (IT); Franco Maino, Brugherio (IT); Ettore Egisto Artoni, Milano (IT); Francesco Marongiu, Lissone (IT)

(21) Appl. No.: 18/191,463

(22) Filed: Mar. 28, 2023

(30) Foreign Application Priority Data
Mar. 29, 2022 (EP) 22425014.2

(51) Int. Cl. B29C 71/02

(52) U.S. Cl. CPC B29C 71/02; B29K 2021/00

(57) ABSTRACT

A method of manufacturing an actuator The method comprises assembling the actuator, and curing the actuator using a predetermined heating profile.

### CROSS-REFERENCE TO RELATED APPLICATIONS

This application claims priority to European Patent Application No. 22425014.2 filed Mar. 29, 2022, the entire contents of which is incorporated herein by reference.

### TECHNICAL FIELD

This disclosure relates to methods of manufacture of actuators and the manufactured actuators, and, in particular, to the manufacture of actuators with decreased leakage and improved and consistent frequency response characteristics.

### BACKGROUND

Actuators with decreased leakage and improved and consistent frequency response characteristics relative to currently known actuators are desirable generally. Such actuators are particularly desirable for safety critical uses where leakage and/or unpredictable or inconsistent frequency response characteristics are detrimental to the performance and hence safety of the apparatus in which such actuators are located. An example of such actuators are the actuators for use in the control of helicopter or other rotorcraft actuation system rods.

### SUMMARY

According to the present disclosure there is provided a method of manufacturing an actuator. The method includes: assembling the actuator; and curing the actuator using a predetermined heating profile.

In an embodiment of the above embodiment, the actuator comprises an actuator body and an actuator arm which can move between a retracted and an extended position. The actuator includes one or more seals between the actuator body and actuator arm. Those seals are formed from an elastomeric element, typically called a seal energizer, and a Polytetrafluoroethylene (PTFE) seal element, also called seal cap.

In an embodiment of any of the above embodiments, the curing of the actuator is performed in a temperature-controlled environment, for example in an oven or a climatic chamber.

In an embodiment of any of the above embodiments, after curing, the actuator is removed from the oven and allowed to cool to ambient temperature.

An advantage of the method off the present disclosure is that the heating of the actuator and the curing of the actuator, and in particular the seals within the actuator, that results from that heating creates an actuator with consistent and predictable frequency response characteristics both immediately after the curing of the actuator and the seals therein by exposure to the heating profile, and after exposure to the levels of vibration experienced by the components of helicopters or other rotorcraft.

In an embodiment of any of the above embodiments, the predetermined heating profile comprises at least one heating phase, and at least one temperature maintenance phase.

In an embodiment of any of the above embodiments, at least one heating phase comprises heating the actuator at a heating rate of between 80° C. and 200° C. per hour. The heating rate is the rate at which the temperature of the actuator rises.

In an embodiment of any of the above embodiments, each heating phase comprises heating the actuator at a heating rate of between 80° C. and 200° C. per hour.

In an embodiment of any of the above embodiments, the heating rate is between 90° C. and 110° C. per hour.

In an embodiment of any of the above embodiments, the heating rate is 96° C.±4° C., ±3° C., or ±2° C. per hour.

In an embodiment of any of the above embodiments, the heating profile comprises a first and a second heating phase. The first heating phase occurs chronologically before the second heating phase.

In an embodiment of any of the above embodiments, the first heating phase has a longer duration than the second heating phase.

In an embodiment of any of the above embodiments, the first heating phase has a period of between 1.0 and 1.5 hours, and optionally of 1.25 hours.

In an embodiment of any of the above embodiments, the second heating phase has a period of between 0.1 and 0.2 hours, and optionally of 0.15 hours.

In an embodiment of any of the above embodiments the temperature of the actuator at the end of a first heating phase is between 115° C. and 125° C.

In an embodiment of any of the above embodiments the temperature of the actuator at the end of the second heating phase is between 5° C. and 15° C. hotter than the temperature at the end of the first heating phase.

In an embodiment of any of the above embodiments, the temperature of the actuator at the end of the first heating phase is 120° C.

In an embodiment of any of the above embodiments, the temperature of the actuator at the end of the second heating phase is 135° C.

In an embodiment of any of the above embodiments, the heating profile comprises a first and a second temperature maintenance phase. A temperature maintenance phase is a phase during which the actuator is kept at a consistent temperature ±4° C., at a consistent temperature ±3° C., at a consistent temperature ±2° C., or at a consistent temperature ±1° C.

In an embodiment of any of the above embodiments, the second temperature maintenance phase has a longer duration than the first temperature maintenance phase.

In an embodiment of any of the above embodiments, the second temperature maintenance phase has a duration of between 2.5 and 3.5 times the duration of the first temperature maintenance phase.

In an embodiment of any of the above embodiments, the first temperature maintenance phase has a duration of between 2.7 and 3.3 hours, or 3.0 hours.

In an embodiment of any of the above embodiments, the second temperature maintenance phase has a duration in the range of 8 to 9 hours.

According to a second aspect of the present disclosure there is provided an actuator manufactured using a method according to the first aspect of the present disclosure.

According to a third aspect of the present disclosure there is provided a rotorcraft including at least one actuator manufactured using a method according to the first aspect of the present disclosure.

### BRIEF DESCRIPTION OF THE DRAWINGS

The present disclosure will be further described and explained by way of example and with reference to the accompanying drawings in which:

FIG. 1 shows a schematic sectional view of a representative actuator;

FIG. 2 shows a flow chart of an embodiment of a method according to the present disclosure;

FIG. 3 shows an embodiment of a heating profile used in the method of FIG. 2;

FIG. 4 shows details of the frequency response characteristics of an actuator according to FIG. 1 manufactured according to the method of FIG. 2 after the actuator has been subject to the heating profile of FIG. 3; and

FIG. 5 shows details of the frequency response characteristics of an actuator according to FIG. 1 manufactured according to the method of FIG. 2 after the actuator has been subject to the vibrations typical of a rotorcraft.

### DETAILED DESCRIPTION

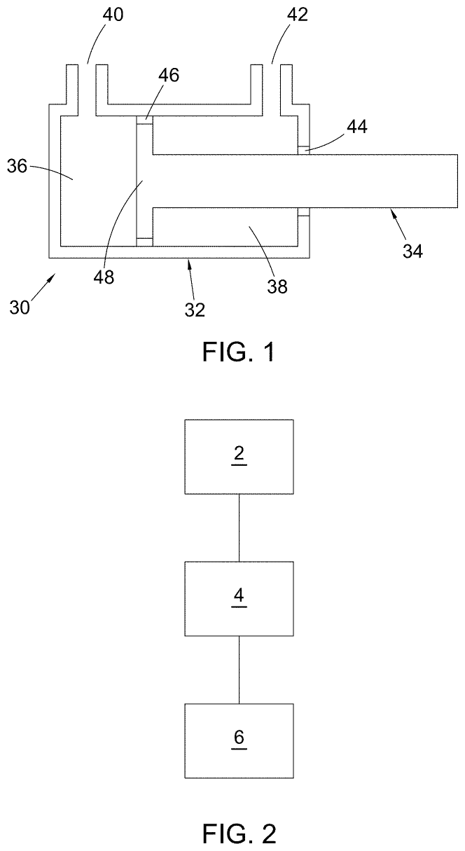

With reference to FIG. 1, an actuator 30 comprises an actuator body 32 and an actuator arm 34. The actuator body 32 defines a void which is split into a first chamber 36 and a second chamber 38 by a first end 48 of the actuator arm 34. One or more seals 46 extend between the first end 48 of the actuator arm 34 and the actuator body 32. The seal or seals 46 prevent fluid communication between the first and second chambers 36, 38.

The actuator arm 34 extends out of the actuator body 32 via an aperture (not labelled). The face or faces of the actuator body that define the aperture support one or more seals 44. The seal or seals 44 prevent fluid communication between the second chamber 38 and the outside of the actuator body 32.

Fluid may enter into and exit from the first chamber 36 via a conduit 40. Fluid may be enter into and exit from the second chamber 38 via a conduit 42. In use, fluid will enter one of the first and second chambers 36, 38 and exit the other of the chambers. Entry and exit of the fluid into/out of the first and second chambers 36, 38 causes the actuator arm 34 to move between a retracted position where the first chamber 36 has a minimum volume and second chamber 38 a maximum volume, and an extended position where the first chamber 36 has a maximum volume and second chamber 38 a minimum volume.

A factor that affects the frequency response of the actuator 30 is the friction and other characteristics of the seals 44, 46 in the actuator.

With reference to FIG. 2, to improve the frequency response of the actuator 30 and to render that frequency response more consistent over time, that is during the working life of the actuator 30, the actuator 30 is first assembled in method step 2 of FIG. 2. The actuator 30 is next, in method step 4, placed into an oven (not shown) and exposed to a predetermined heating profile. Once the heating profile is completed, the actuator 30 is, in method step 6, removed from the oven and allowed to cool to ambient temperature. The actuator 30 may then be used, for example in a helicopter, to move a control rod engaged with a lower swash plate of the helicopter.

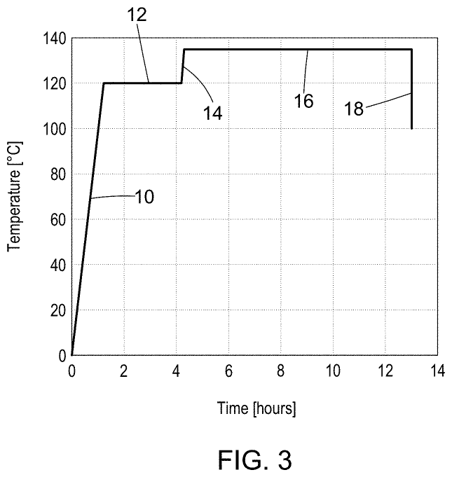

With reference to FIG. 3, an example of a heating profile according to the present disclosure is shown as a plot of the temperature of the actuator against time. In the heating profile the actuator 30 is heated by the oven for a first heating phase 10. The gradient of the plot for heating phase 10 indicates the heating rate in the first phase. In the illustrated embodiment the gradient represents a heating rate of 96° C. per hour.

Once the actuator has reached a predetermined temperature (120° C. in the present embodiment) the oven ceases to increase the temperature of the actuator 30. The oven and actuator 30 now enters a first temperature maintenance phase 12 during which phase the oven keeps the actuator 130 at a temperature of 120° C.±4° C. The first temperature maintenance phase 12 has a period of 3 hours.

At the end of the first temperature maintenance phase 12 a second heating phase 14 commences. The second heating phase 14 raises the temperature of the actuator 30 by 15° C. to a temperature of 135° C. Again the heating rate of the actuator 30 is 96° C. per hour.

When the actuator 30 achieves the temperature of 135° C. the second temperature maintenance phase 16 starts. The second temperature maintenance phase 16 has a period of between 8 and 9 hours.

At the end of the second temperature maintenance phase 16 the actuator 30 is removed from the oven and allowed to cool to ambient temperature as represented by plot 18 in FIG. 3.

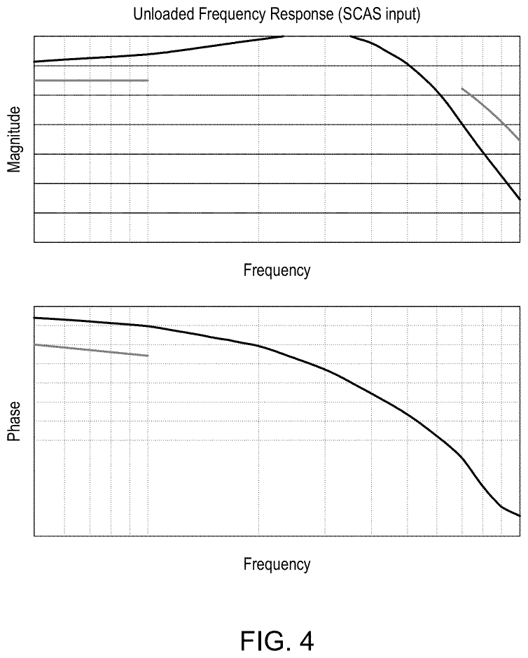

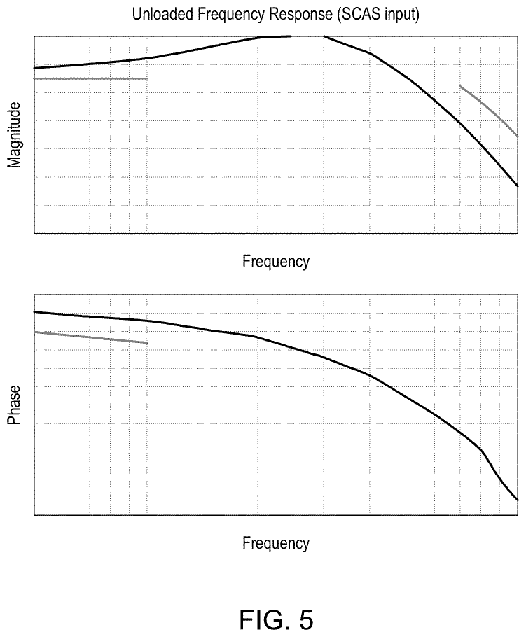

With reference to FIGS. 4 and 5, these show the frequency response plots for the actuator 30 after the actuator 30 has returned to ambient temperature (FIG. 4), and after the actuator has been exposed to levels of vibration that are typically experienced by components of a helicopter (FIG. 5). It may be seen that the frequency responses are very similar to each other.

The frequency response plots were obtained by a Fast Fourier Transform (FFT) method, with input and output signals representative of typical helicopter main rotor actuation operation. The hydraulic fluid within the actuator was at room temperature.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods disclosed in the various embodiments may be used alone, in combination, or in a variety of arrangements not specifically discussed in the embodiments described above. This disclosure is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A method of manufacturing an actuator, the method comprising:
assembling the actuator; and
curing the actuator using a predetermined heating profile.

2. A method according to claim 1, in which the predetermined heating profile comprises at least one heating phase, and at least one temperature maintenance phase.

3. A method according to claim 2, in which at least one heating phase comprises heating the actuator at a heating rate of between 80° C. and 200° C. per hour.

4. A method according to claim 3, in which each heating phase comprises heating the actuator at a heating rate of between 80° C. and 200° C. per hour.

5. A method according to claim 3, in which the heating rate is between 90° C. and 110° C. per hour.

6. A method according to claim 1, in which the heating profile comprises a first and a second heating phase.

7. A method according to claim 6, in which the first heating phase has a longer duration than the second heating phase.

8. A method according to claim 6, in which the first heating phase has a period of between 1.0 and 1.5 hours.

9. A method according to claim 8, in which the first heating phase has a period of 1.25 hours.

10. A method according to claim 6, in which the second heating phase has a period of between 0.1 and 0.2 hours.

11. A method according to claim 6, in which the second heating phase has a period of between 0.15 hours.

12. A method according to any of claim 6, in which one or both of the temperature of the actuator at the end of the first heating phase is 120° C., and the temperature of the actuator at the end of the second heating phase is 135° C.

13. A method according to claim 1, in which the heating profile comprises a first and a second temperature maintenance phase.

14. A method according to claim 13, in which the second temperature maintenance phase has a longer duration than the duration of the first temperature maintenance phase.

15. A method according to claim 13, in which the first temperature maintenance phase has a duration of 3 hours or between 2.7 and 3.3 hours.

16. A method according to any of claim 15, in which the second temperature maintenance phase has a duration in the range of about 8 to about 9 hours.

17. An actuator manufactured using a method according to claim 1.
